(19) United States
(12) Patent Application Publication
(10) Pub. No.: US 2026/0205049 A1
(43) Pub. Date: Jul. 16, 2026

(54) Window-wall and Curtainwall Energy System

(71) Applicant: Wayne Lawrence LONG, Cambridge (CA)

(72) Inventor: Wayne Lawrence LONG, Cambridge (CA)

(21) Appl. No.: 19/136,742

(22) PCT Filed: Nov. 20, 2023
(86) PCT No.: PCT/IB2023/061709

§ 371 Date: Jun. 6, 2025

Related U.S. Application Data
(60) Provisional application No. 63/432,796, filed on Dec. 15, 2022.

(51) Int. Cl. H02S 20/26; E04B 2/96

(52) U.S. Cl. CPC H02S 20/26; E04B 2/962

(57) ABSTRACT

The present specification pertains to an innovative solar electric energy wall system designed for building structures. The system is composed of numerous solar spandrels and vision panels, seamlessly integrated into standard unitized window wall units, commonly used for cladding building exteriors. These units incorporate electrical wiring within their frames, arranged in both vertical and horizontal orientations, enabling efficient capture and distribution of solar energy while maintaining aesthetic and functional attributes of conventional building design. Rapid replacement of the solar spandrels is contemplated.

### PRIORITY CLAIM

The present specification claims priority to U.S. Provisional Patent Application 63/432,796 filed Dec. 15, 2022, the contents of which are incorporated herein by reference.

### FIELD

The present specification relates generally to building materials and more particularly to the integration of renewable energy systems into building materials.

### BACKGROUND

Renewable energy in the form of solar energy created from the use of photovoltaic solar cells are known, however the efficiency, practicality and cost effectiveness has been lagging. The most widely deployed prior art typically focuses on separate building materials for creating the building enclosure and separate photovoltaic structures such as solar panels which are mounted on or proximate to the building structure. The vision of building-integrated photovoltaics (BIPV) combines photovoltaic materials in parts of the building materials in parts the building. For example, U.S. Pat. No. 8,381,465, contemplates a commercial unitized curtainwall system that integrates standard solar active panels within the frame, thereby integrating photovoltaic cells and wiring conduits into a building structure, but this can overly limit certain design choices of different types of building structures.

### SUMMARY

The present specification pertains to an innovative solar electric energy wall system designed for building structures. The system is composed of numerous solar spandrels and vision panels, seamlessly integrated into standard unitized window wall units, commonly used for cladding building exteriors. These units incorporate electrical wiring within their frames, arranged in both vertical and horizontal orientations, enabling efficient capture and distribution of solar energy while maintaining aesthetic and functional attributes of conventional building design. Rapid replacement of the solar spandrels is contemplated.

An aspect of the specification provides a solar electric energy wall system including: a plurality of solar spandrels and vision panels integrated into standard unitized window wall units for cladding a building structure; said plurality of unitized window wall units further carrying electrical wiring within at least a portion of the frames of said plurality of unitized window wall units.

An aspect of the specification provides a solar electric energy wall system wherein a plurality of control modules are integrated within said unitized window wall units; said control units each optimizing a power output of at least one of said plurality of energy conversion devices.

An aspect of the specification provides a solar electric energy wall system including: a plurality of interconnected unitized window wall units defining an exterior shell for a building structure; a plurality of photovoltaic energy conversion devices integrated within said plurality of interconnected unitized window wall units; wherein at least some of said photovoltaic energy conversion devices can be oriented substantially vertically with respect to said building structure at least during certain periods; said plurality of interconnected unitized window wall units further defining and forming a plurality of integrated vertical and horizontal electrical conduits adapted to carry electrical wiring for said plurality of interconnected unitized curtain wall units and to contain control circuitry for said plurality of energy conversion devices; wherein the photovoltaic power generating system is integrally incorporated within said plurality of interconnected unitized curtain wall units.

An aspect of the specification provides a system, wherein said exterior shell encloses a substantial portion of a vertical surface of said building structure which receives solar radiation.

An aspect of the specification provides a solar electric energy wall system including: a plurality of solar spandrels and glass vision panels integrated into unitized cladding wall units for cladding a building structure; said plurality of unitized cladding wall units further carrying electrical wiring within at least a portion of the frames of said plurality of unitized cladding units.

An aspect of the specification provides a solar electric energy wall system wherein a plurality of control modules are integrated within said unitized window wall units; said control units each optimizing a power output of at least one of said plurality of energy conversion devices.

An aspect of the specification provides a solar electric energy wall system wherein the solar spandrels and glass vision panels are disposable or recyclable around a substantial portion of the building structure.

An aspect of the specification provides a solar electric energy wall system wherein the solar spandrels are removably replaceable and/or recyclable within each cladding wall unit.

An aspect of the specification provides a cladding panel for a building including: a frame having at least one vertical member and at least one horizontal member; at least one solar spandrel disposed within the frame having an electrical connection; a photovoltaic surface of the spandrel for positioning on the exterior of the building; a set of wiring passing at least through the at least one vertical member for delivery to a junction box disposed in a floor or ceiling of the building proximal to the at least one horizontal member; the wiring for delivery of electricity from the electrical connection to the junction box.

An aspect of the specification provides a system, wherein said exterior shell encloses a substantial portion of a vertical surface of said building structure which receives solar radiation.

An aspect of the specification provides a cladding panel wherein the electrical connection is removably connectable to the wiring and the photovoltaic spandrel is removably mountable within the frame, such that the solar spandrel is replaceable during maintenance of the building.

An aspect of the specification provides a cladding panel wherein the photovoltaic spandrel is removably securable within the frame using a plurality of removable fasteners along the periphery of the photovoltaic spandrel.

An aspect of the specification provides a cladding panel wherein the fasteners include one or more of screws, wingnuts, thumbscrews, snap fasteners, quick-release pins and magnets.

An aspect of the specification provides a cladding panel further including an insulation layer between the solar spandrel and the interior of the building.

An aspect of the specification provides a cladding panel wherein the insulation layer is vacuum sealed insulation panel having a thickness of about one inch.

An aspect of the specification provides a cladding panel wherein the insulation layer has a thermal insulation rating of about R65.

An aspect of the specification provides a cladding panel further including at least one transparent glass unit adjacently positioned within the frame beside the solar spandrel.

An aspect of the specification provides a cladding panel wherein the panel includes a corner mullion to form a corner panel for the building.

An aspect of the specification provides a cladding panel wherein the panel is part of a window wall system.

An aspect of the specification provides a cladding panel further including a control unit for normalizing an electricity profile generated by the photovoltaic surface with the profile of a power grid for the building.

An aspect of the specification provides a cladding panel wherein the at least one vertical member includes a joining mechanism for interlocking attachment to a complementary vertical member of a frame of an adjacent cladding panel.

An aspect of the specification provides a cladding panel wherein the adjacent cladding panel also includes at least one solar spandrel.

### BRIEF DESCRIPTION OF THE DRAWINGS

FIG. 1 shows an exterior wall of a window wall system in accordance with an embodiment.

FIG. 2 shows a portion of the exterior wall of FIG. 1.

FIG. 3 shows the portion of the window wall system according to the detail-callout labelled 3 in FIG. 1.

FIG. 4 shows the portion of the window wall system according to the detail-callout labelled 4 in FIG. 1 and the detail-callout labelled 4 in FIG. 3.

FIG. 5 shows the portion of the window wall system according to the detail-callout labelled 5 in FIG. 1 and the detail-callout labelled 5 in FIG. 3.

FIG. 6 shows the portion of the window wall system according to the detail-callout labelled 6 in FIG. 1 and the detail-callout labelled 6 in FIG. 3.

FIG. 7 shows a section of a horizontal frame member from FIG. 1 according to the detail-callout labelled 7 in FIG. 1.

FIG. 8 shows another window wall system in accordance with another embodiment.

FIG. 9 shows the window wall system of FIG. 8 with reference characters added.

FIG. 10 shows a detail portion of the widow wall system of FIG. 9.

FIG. 11 shows a perspective view of the window wall system of FIG. 8.

FIG. 12 shows an interior perspective view of a corner panel that is a variant of the corner panel from the system of FIG. 11.

FIG. 13 shows an exterior elevation view of the corner panel of FIG. 12.

FIG. 14 shows another exterior elevation view the other side of the corner panel of FIG. 12.

FIG. 15 shows an interior elevation view of the corner panel of FIG. 14.

FIG. 16 shows an interior elevation view of the corner panel of FIG. 13.

FIG. 17 shows a perspective view of a portion of the corner panel of FIG. 12.

FIG. 18 shows a perspective view of another portion of the corner panel of FIG. 12.

FIG. 19 shows a different perspective view of the portion shown in FIG. 18.

FIG. 20 shows a top sectional view of the corner panel of FIG. 12.

FIG. 21 is a detail view of the respective call-out indicated in FIG. 20.

FIG. 22 is a detail view of the respective call-out indicated in FIG. 20.

FIG. 23 is a detail view of the respective call-out indicated in FIG. 20.

FIG. 24 shows a multi-layered top sectional view corresponding to the view of FIG. 20.

FIG. 25 shows a side sectional view of a panel.

FIG. 26 shows a interrupted side sectional view of two panels.

FIG. 27 shows a top sectional view of the corresponding to FIG. 20 but as a variant with an insulation layer.

FIG. 28 is an illustration of the removal and replacement of a photovoltaic unit or solar spandrel.

FIG. 29 is another illustration of the removal and replacement of a photovoltaic unit or solar spandrel.

FIG. 30 shows a non-limiting example of how a photovoltaic unit can be mounted within a frame.

FIG. 31 shows a view of the respective call-out indicated in FIG. 25.

### DESCRIPTION

It should be noted that the drawings are in a format consistent with industry standard aluminum frame residential window wall cladding systems and how they are typically assembled. The wiring within the frames and the installation of solar spandrel panels and vision glass is what the drawings set out to describe in detail.

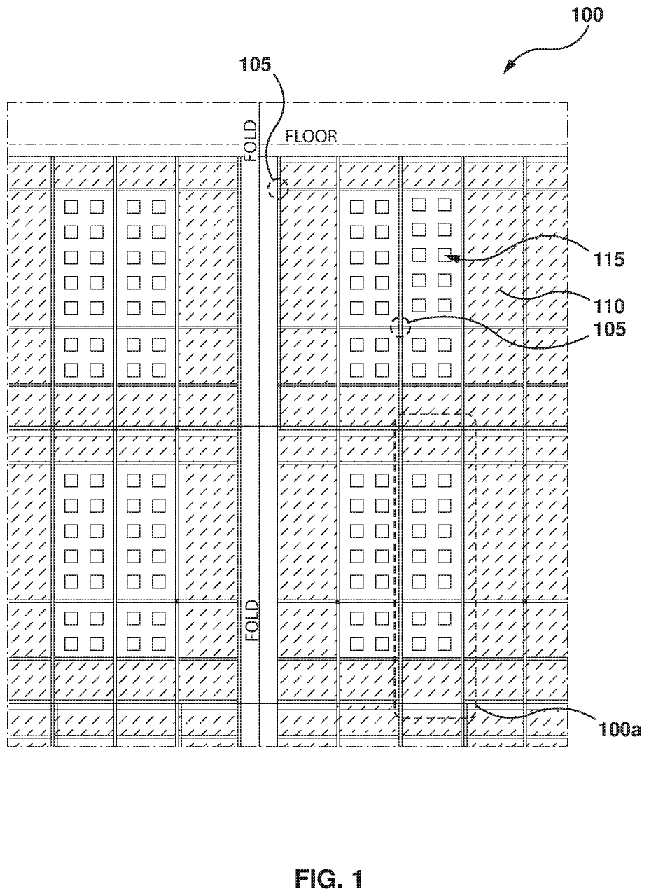

FIG. 1 is an illustration for the typical window wall system assembly from the exterior to illustrate a full assembly of a solar electric energy wall system utilizing standard residential window wall frame components as a support system and solar spandrel and solar glass panels completing the cladding system.

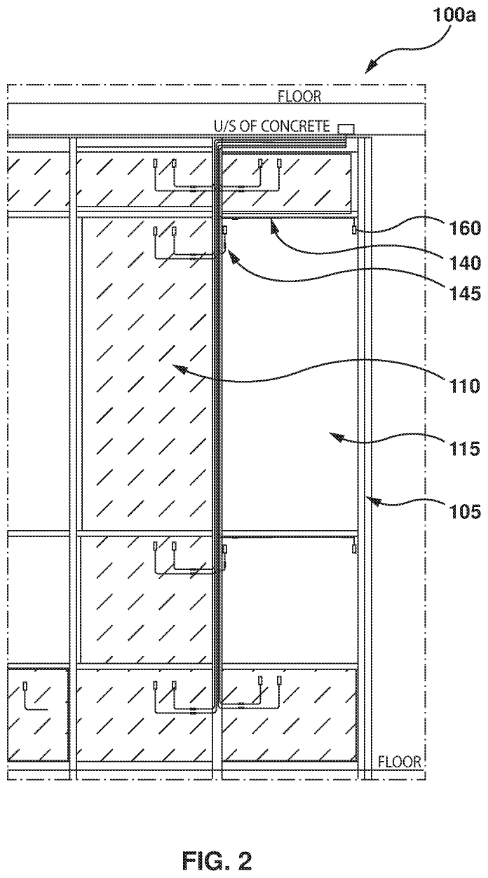

FIG. 2 is an illustration of the interior side of the typical residential window wall assemble illustrating the locations of the solar panel and solar vison glass panels with contacts and wiring on the inside face of the spandrel backpan.

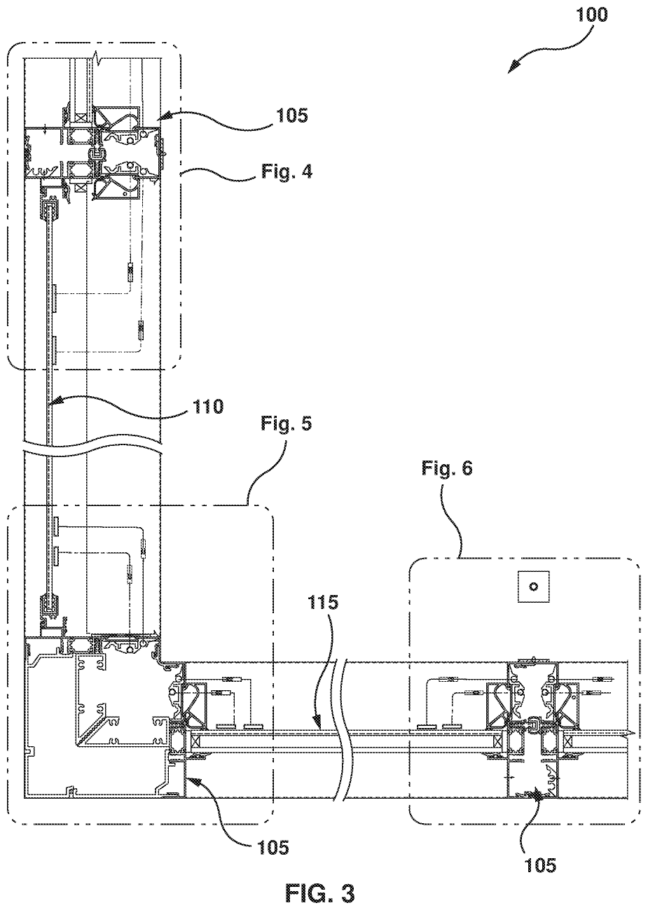

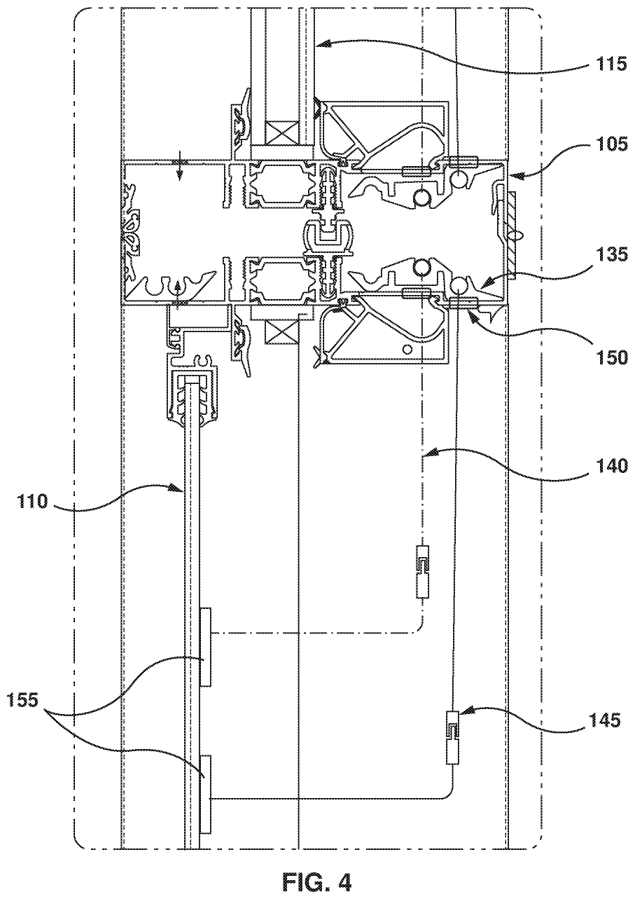

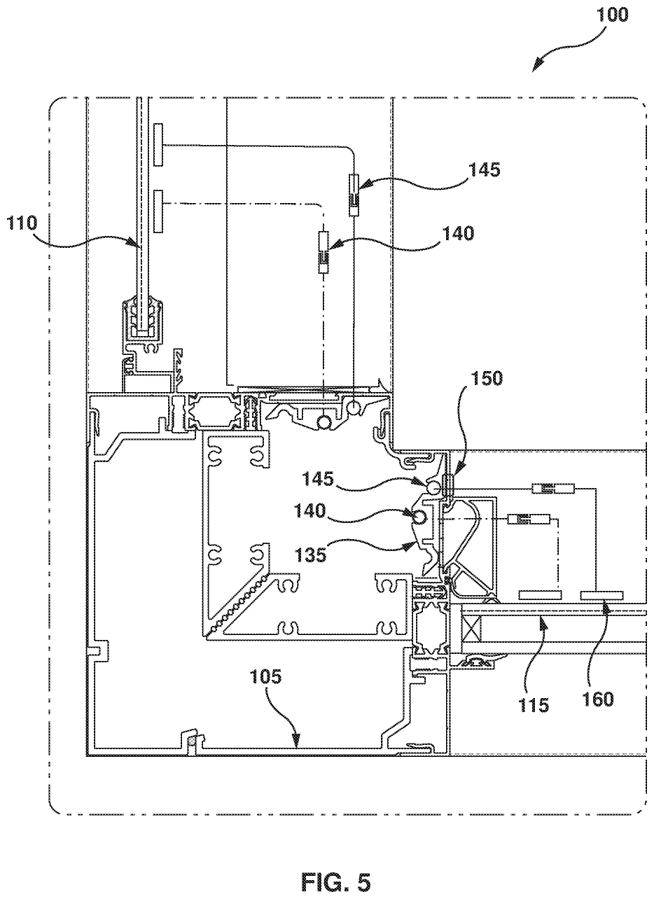

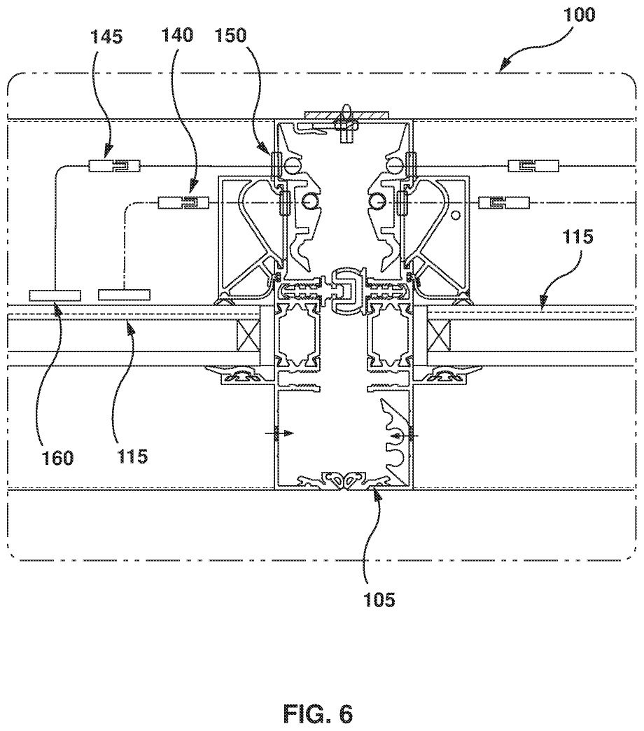

FIG. 3 shows a plan section of a typical corner assembly looking down towards the floor as indicated on FIG. 1 and designated with a detail-callout labelled 3. FIG. 3 also shows the location of larger scale details FIG. 4, FIG. 5 and FIG. 6, in relationship to each other and illustration a solar spandrel panel in a standard frame, a corner framing profile and a solar vision glass panel in a standard frame that make up the Solar Energy Window wall Cladding System.

FIG. 4, FIG. 5 and FIG. 6, shows a detailed plan section looking towards the floor as noted on FIG. 1 and FIG. 3. (The detail-callout labelled 4 is respective to FIG. 4; the detail-callout labelled 5 is respective to FIG. 5; and, the detail-callout labelled 6 is respective to FIG. 6) illustrating the relationship of components that make up the Solar Energy Window wall Cladding System. The drawings also illustrates the integration of the solar panels within the frame as well as the wiring and contacts that collect and transmit the energy to the electrical room inverters.

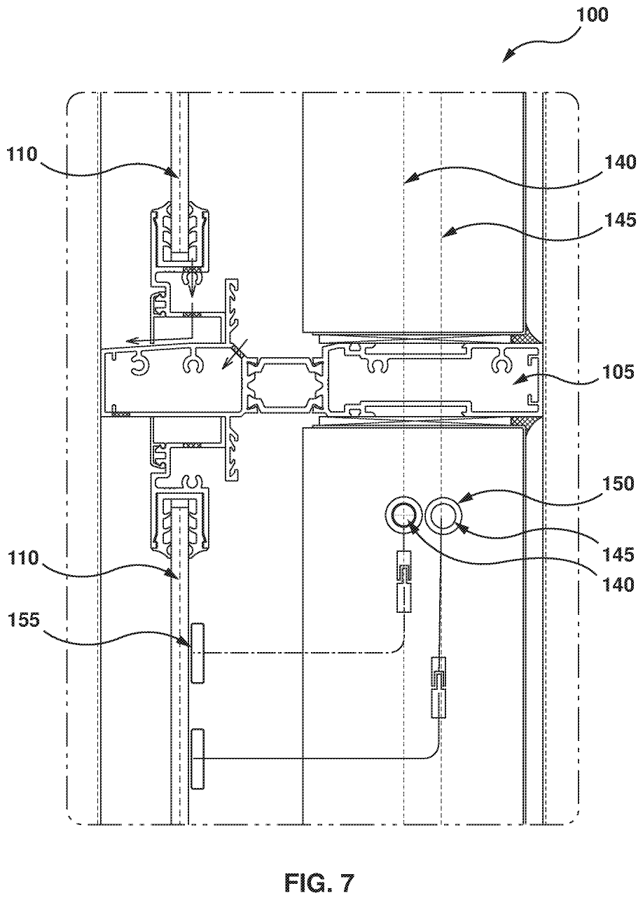

FIG. 7 shows a detailed section of a horizontal frame member supporting a solar spandrel panel above the frame and below the frame and noted on FIG. 1 with a detail-callout labelled 7 illustrating the relationship of components that make up the Solar Electrical Energy Window wall System.

The present specification contemplates a solar electric energy window wall cladding system that can act as a building facade cladding with a unitized window wall systems to provide the weather protection as it is primary intention, and fulfill the vision of building-integrated photovoltaic (BPIV) vision and/or spandrel panels, into a window wall system that can generate electrical energy.

The exterior cladding system of the majority of the building facade with the system, attached to the structural slabs in prefabricated sections is seen as system 100 and as seen in a partial elevation drawing in FIG. 1 and FIG. 1 shows an exterior wall of a window wall system in accordance with an embodiment.

FIG. 2. System interior 100a of FIG. 2 is the inside view of a portion of system 100 and shows wiring on the spandrel panels as well as how the wiring travels vertically from bottom to top and horizontally only along the top of the frame.

The prefabricated unitized window wall system cladding for the entire building using standard aluminum window wall framing elements 105 is configured to extend across multiple stories in continuous units of solar spandrel and solar vision areas. While the elements 105 are shown as separate components they can, in certain embodiments, be assembled in the factory into predetermined sizes and configurations spanning one or more floors (about three meters to about six meters) vertically and about 1.5 meters wide and assembled frame to frame with quick connect wire connections. The panels can be installed frame-to-frame from floor-to-floor to enclose an entire building structure from wall-to-wall and from ground to the roof.

The Window wall elements 105 when fabricated and put together can form an open frame that can accept the cut to-size photovoltaic (PV) module spandrel panel 110 and insulated glass units 115 to fit within the systems using standard installation method as they are commonly assembled in todays market. It is an exchange of non-active spandrel and glass panels with solar active panels 110 and insulated glass units 115 which may be partially or fully transparent.

The spandrel panel 110 can have two energy contacts or electrodes 155 and coloured cables 140 and 145 attached to the inside face of the panel loops and quick connects to a preinstalled wire that passes through a grommet 150 set in a predrilled hole in the vertical window frame that runs to the head of the window across the head and connects to a junction box in the concrete slab.

Each glass unit 115 has two energy contacts or electrodes 160 and coloured cables 140 and 145 attached to the inside face of the panel quick connects to a preinstalled wire that passes through a grommet 150 set in a predrilled hole, in the vertical window frame that runs to the head of the window across the head and connects to a junction box in the concrete slab.

Retainer clips 135 are used to secure the wiring within the frames and allow for easy removal for replacement.

The wires in the junction boxes run through the conduit in the slab and collected in the electrical closets located on each floor and run to the electrical room connected to the inverter, electrical panel, storage battery and bi-directional meter.

The Solar energy system once installed and wired together can be monitored continuously to detect any system failures or energy losses throughout the day. The sources for electrical supply to the building can also be managed on an ongoing basis to determine the least expensive source of electricity, (the building's own energy system at discounted rate, battery back up or supply from the local power supplier) is used at any given hour of the day. This has inherent cost savings for the end users that is not provided in previous systems.

The following methodology can be used to install the window wall panels.

1. Install prefabricated solar panels that have the solar contact and pigtail connector attached, from the exterior side of the window assembly, into the spandrel section of the window assembly. Screw into frame stop to secure into position.

2. Install prefabricated solar vision insulated glass units that have the solar connector and pigtail connector, from the interior side of the window assembly, into the vision portion of the window assembly.

3. Install purpose made glazing gasket between both sides of the solar panel and frame to ensure watertight seal

4. Install purpose made glazing gasket between both sides the solar vision insulated glass unit and frame to ensure watertight seal

5. Install removable exterior trim cover to conceal fasteners in spandrel panel for future access and panel replacement from the exterior

6. Leave wires bundled behind panel until assembly of the unit are completed

7. Preinstall silicone grommets into hole in frame to protect cables during installation and connection

8. Pull fish or run the system connection cables cut to length with male I female connectors though the predrilled holes and plug into panel connectors to complete the circuit in series. Not to exceed the maximum allowable load for each circuit.

9. Run the cable from the assembled and connected panels to the junction box in an adjacent wall ceiling or other concealed location.

10. Provide conduit with pull string from the junction box at the installed Solar Electric (Energy Wall) Window, window wall to the electrical room to the inverter, electrical panels, switches, meter to complete the full installation of a unitized residential window wall assembled section.

11. Following the same installation methodology install the remainder of the enclosure, system, until each floor is completed, and the entire facade is covered with a full residential window wall installed over and enclosing the entire structure.

Fabrication of the window frames can be effected so as to allow for installation of the solar panels and solar vision panels with pre-cut holes located in a manner to allow for the passing of cables with connectors through the frame to connect all of the panels together using prefabricated cable quick connectors.

1. Aluminum window frames are sized and cut to length for the entire unitized window frame assembly, based on approved shop drawings as in standard assembly sequence. Not part of the claim

2. The frames have machined, punched or drilled holes, installed to align with the solar panel connection wire location in the spandrel panel section of the window. The holes shall be only in a size large enough to allow for the passing or cables and the cable connectors to pass through plus the thickness of the grommet.

3.—The frames have machined, punched or drilled holes installed to align with the vision panel connection wire location in the vision panel section of the window. The holes shall be only in a size large enough to allow for the passing or cables and the cable connectors to pass through plus the thickness of the grommet.

4.—silicone or rubberized or synthetic material grommets are installed in the precut holes to prevent cables from being damaged.

The following method can be used for connecting panels together and wiring them.

1.—The connection of the individual panels together within the assembled window system using connecting cables, cut to length with male female patented connectors plugging in to each other must be accessible for ease of disconnecting to allow for replacement of connectors, cables or other component parts of the system.

2.—Locate all connectors in accessible locations to allow for replacement of solar panels, solar vision glass or connectors and cables and hold down clips.

3.—Run all primary connection cables, within the window frame and clip into place with plastic hold down clips every about 2′-0″ (or about 600 mm). The cable can have a length of about 24″ (600 mm) longer than the length of the frame, from hole to hole. The cable can have with one male and one female connector on each cable, and the cable needs to be pulled through the access hole in the frame to the inside of the spandrel panel.

4.—Once the main cables are pulled into the spandrel from the frame side, connect the main cables to the solar panel and vision panel cables.

1. SOLAR SPANDREL PANELS

2. SOLAR VISION PANELS

3. CONNECTORS WITH CABLE ATTACHED TO SOLAR CELLS

4. RED AND BLACK CONNECTOR CABLE WITH ONE MALE ONE FEMALE CONNECTOR

WIW WIRING DIAGRAM

5. MISCELLANEOUS CLIPS AND FITTINGS

6. ALUMINUM WINDOW FRAMING

7. GLAZING GASKETS AND SEALS

The Solar energy system can be monitored continuously to detect any system failures or energy losses throughout the day. The sources for electrical supply to the building can also be managed on an ongoing basis to ensure the least expensive source of electricity, (the buildings own energy system at discounted rate, battery back up or supply from the local power supplier,) is used at any given hour of the day. This has inherent cost savings for the end users.

The present specification can provide a system for integration and installation of solar cell panels and/or solar cell glass panels into an aluminum window wall system to create a solar electric energy window wall cladding system.

This system provides a proven residential window wall system assembly composed of vison and spandrel panels in aluminum framing, and convert it to solar electrical energy window wall cladding system by replacing the standard glass and spandrel panels with solar cell, glass and spandrel panels in the frame assembly.

The internal channels, that are the result of putting two frames together, allow for easy installation of all the main wires to run vertically from bottom to top of the frame where they are then run along the top of the top track to the junction box located in the poured concrete slab. The junction boxes are preinstalled in the poured concrete slab, with conduit running to the electrical risers' closets and further runs to the main electrical room where it further connects to all of the back of house equipment such as invertors, electrical panel, electrical meter and power monitoring and management systems, that will be described latter.

The main wires are further plug and play connected thru drilled holes in the vertical frame sections to connect to the inside face of the spandrel and glass panels, thru grommets.

The wiring in the vertical frames are clipped into the frame using purpose made clips to allow for secure fastening and ease of replacement.

Connecting the panels together in arrays both vertically and horizontally with wires fed to a standard junction box through in slab conduit to collectors boxes in a common electrical closet on each floor to the primary electrical room where is connects all circuits to an invertor to convert the electrical current from direct current to alternating current, the energy flows to the distribution panels back into the building system or battery storage or the bi-directional meter back to the local power grid to gain credits for future use.

A full time electrical monitoring system can be provided to continually monitor system efficiency, and can be configured to pinpoint any power lose within a panel area that may be under performing. Panels that are underperforming can be identified and flagged for repair or replacement according to certain criteria, such as a point when there are sufficient panels that underperforming as a percentage of the total system.

A full-time electrical management system can continually monitor the electrical usage and utilize the least costly energy any time of the day and can automatically switch between power grid, solar energy wall or battery to supply the energy to the entire building. This can provide cost savings for the users and is an integral component to the entire system.

It is understood from that the system can be implemented in a variety of ways, and it is a solar electrical energy window wall cladding system and it will be apparent to those skilled in the trade that it could be used in any number of applications.

The subject of this specification provides a new system for a residential window wall that can provide certain advantages over the prior art including, depending on the embodiment, one or more of:
reducing the complexity (including cost) of an overall unitized curtainwall system and benefit the residential building systems which are different from commercial building systems;
integration of a conduit inside the standard closed box window frame;
providing wiring into the conduit inside closed hollow box frame system; and,
adapting the conduit inside the curtainwall frame system in two directions; and
replacing the wiring at any future time; and
installing a solar panel that has cables and a contact on the slim edge of the panel, and keep them intact while setting them into the frames, and
passing the wiring through holes in the conduit within frame without damaging the wires or the contacts; and
accessing the wires in the future to upgrade or replace if defective; and
replacing the spandrel and glass panels without the need to rewire the entire system; and
integrate the contacts to the ends of the solar panels.

While the simplicity of the principal of installing solar panels into a window frame system for commercial buildings using commercial grade curtainwall frames in unitized systems, to create electrical energy can be worthwhile, scaling is challenging, as they are complex unforgiving, difficult to integrate the various conduits, solar panels and are generally impractical for the residential low-rise, mid-rise and high-rise industry.

The Window Wall framing system of the present specification can improve and simplify the assembly of the aluminum framing and the wired solar panel components that require the factory fabricate, assemble, and further to maintain the Solar Electric Energy Window Wall Cladding System, for at least some of the following reasons:
it simplifies the integration of all components the utilizing frames that must be assembled in two parts to create a single support frame allowing wiring to run in the frame and be clamped into position;
it simplifies replacement of spandrel and glazed vision panels, plug and play wire connectors are connected to the inside face of the panels and the panels all replaceable from the exterior;
the surface mounted contacts on the inside of spandrel panels protects the wiring from the elements;
the plug and play wire connectors attached to the individual components with individual wiring between components allows for ease of replacements of individual component panels; and
an indicator light such as light emitting diode within an identification name plate, where the light can be visible on the inside within the interior of the room, during all daylight hours that indicates the solar panels are collecting energy; and,
it can simplifies the installation of the wiring within the framing system both vertically and horizontally.

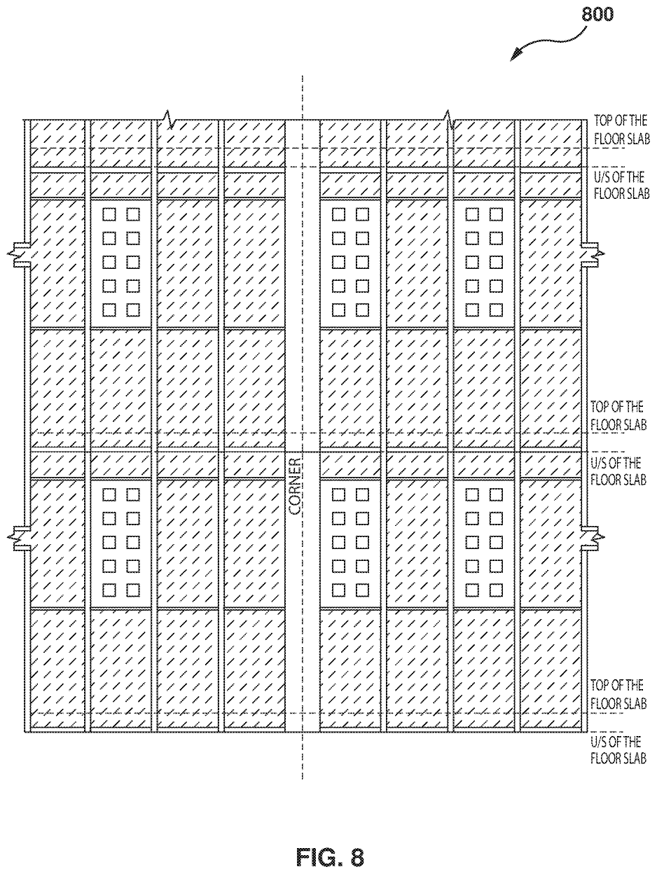

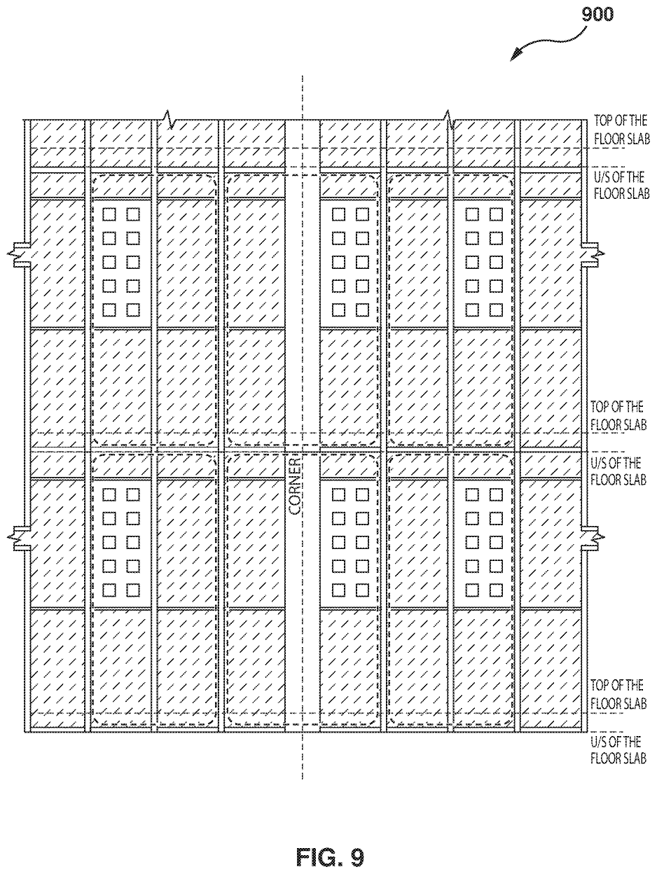

Referring now to FIG. 8 and FIG. 9, a window wall system in accordance with an embodiment is indicated generally at 800 for use on an exterior of a building 804. FIG. 8 and FIG. 9 show the exact same system 800, however, in FIG. 8 reference characters are omitted to reduce visual clutter. Considering FIG. 8 and FIG. 9 together, along with this text, will assist in understanding system 800.

As labelled in FIG. 9, system 800 includes a plurality of elements including panels 808. Window wall panels 808 are disposed across the exterior of building 804. Only a portion of the building 808 is shown and so the elements in FIG. 9 repeat along at least a portion of the exterior of the building 808 to provide the window wall system 800.

Thus, only a portion of a first floor 812-1 and a portion of a second floor 812-2 are shown. (The terms “first floor” and “second floor” are not intended to convey any literal position or level in relation to a ground floor, rather to distinguish between a first lower floor and a second upper floor. The panels 808 discussed herein can be used on any floor of a building, suitably modified.)

Panels 808 repeat across the exterior of building 800. A first left panel 808-L-1 is shown on first floor 812-1, and a second left panel 808-L-2 is shown on second floor 812-2. A first right panel 808-L-2 is shown on first floor 812-1, and a second right panel 808-R-2 is shown on second floor 812-2. A first corner panel 808-C-1 is shown on first floor 812-1, and a second corner panel 808-C-2 is shown on second floor 812-2. Not all panels 808 are labelled in FIG. 9, as only a portion of panels 808 are shown at the periphery of building 804.

A brief word about nomenclature: collectively, floor 812-1 and floor 812-2 are referred to as floors 812, and generically, as floor 812. Similarly, collectively, left panel 808-L-1 and left panel 808-L-2 are referred to as left panels 808-L and generically as left panel 808-L. In panel 808-L-X, the “X” corresponds to the level of the floor 812-“X”. This nomenclature is used elsewhere herein, including for corner panels 808-C and right panels 808-R. Sometimes specific labels are reference characters are used in Figures, other times generic ones are used, according to the context of this narrative. Thus, collectively, the panels are referred to as panels 808, and generically as panel 808.

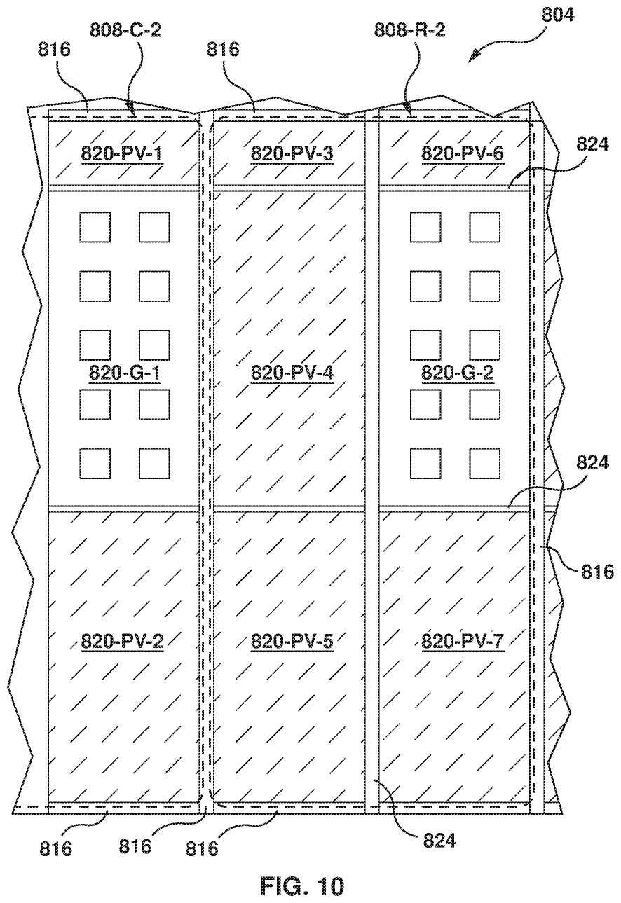

FIG. 10 shows the entirety of panel 808-R-2 and a portion of panel 808C-2 in greater detail. Each panel 808 includes a frame 816 along the periphery of the panel 808, and each panel 808 can include one or more units 820. Where a given unit 820 does not contact the frame 816, the unit 820 is supported by mullions 824, which are vertical or horizontal elements within the frame 816 that separate each unit 820.

Each unit 820 can be of the same or a different type. In FIG. 10, photovoltaic units 820-PV are shown along with glass units 820-G. The combination of types and sizes of units 820 within each panel 808 can be selected according to the desired aesthetic and functional characteristics of the panel 808. In FIG. 10, the portion of panel 808-C-2 that is shown has a glass unit 820-G-1, a photovoltaic unit 820-PV-1 and a second a photovoltaic unit 820-PV-2, while panel 808-R-2 has a single glass unit 820-G-2 and five photovoltaic units 820-PV, namely photovoltaic unit 820-PV-3, photovoltaic unit 820-PV-4, photovoltaic unit 820-PV-5, photovoltaic unit 820-PV-6, and photovoltaic unit 820-PV-7. As will be discussed in further detail below, each photovoltaic unit 820-PV is an active spandrel capable of generating electricity from light incident upon each photovoltaic unit 820-PV. A photovoltaic unit 820-PV may also be referred to as a solar spandrel. (In variants, some spandrels may be traditional spandrel units 820 and therefore non-solar, and otherwise inactive in terms of electricity generation.)

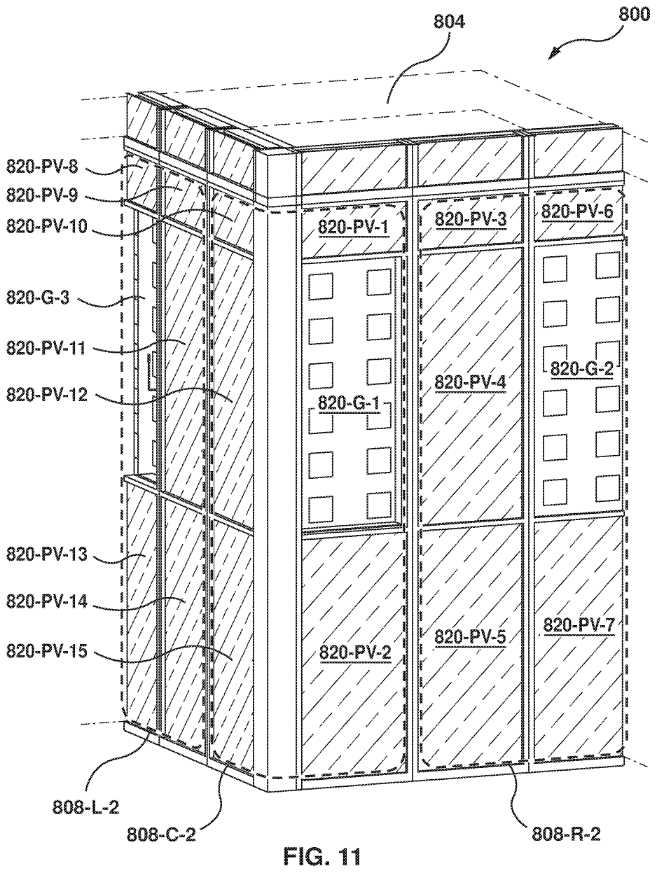

Referring now to FIG. 11, a perspective view of system 800 is shown that roughly corresponds with a portion of the second floor 812-2 from the flat elevation view of FIG. 8 and FIG. 9. Glass unit 820-G-3 associated with panel 808-L-2 is labelled, as well as photovoltaic unit 820-PV-8, photovoltaic unit 820-PV-9, photovoltaic unit 820-PV-11, photovoltaic unit 820-PV-13 and photovoltaic unit 820-PV-14 are labelled as being associated with panel 808-L-2. By the same token, photovoltaic unit 820-PV-10, photovoltaic unit 820-PV-12, and photovoltaic unit 820-PV-15 are labelled as part of corner panel 808-C-2.

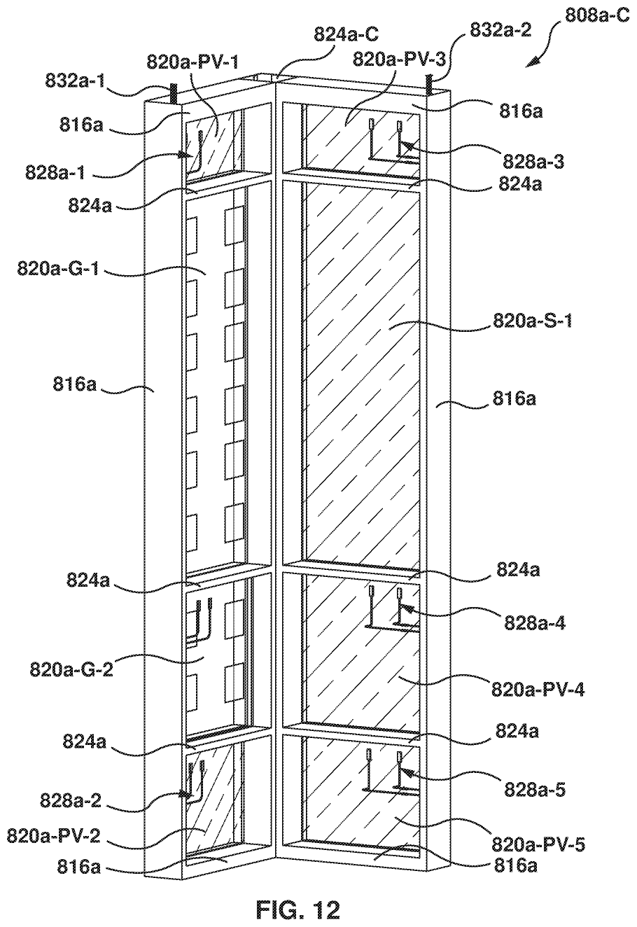

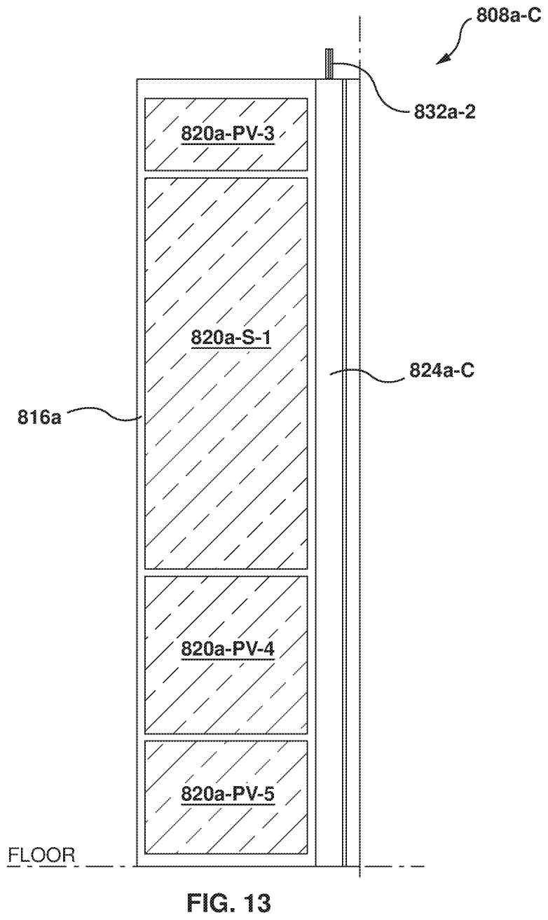

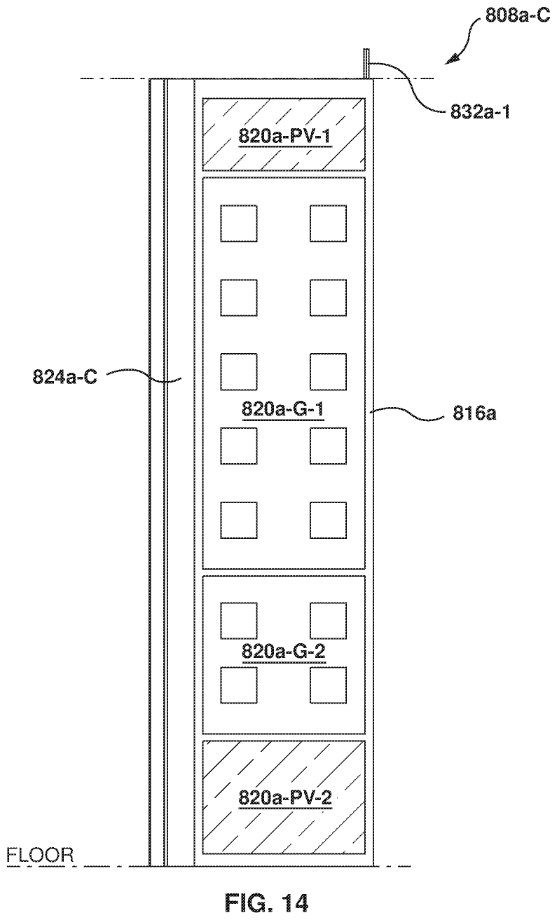

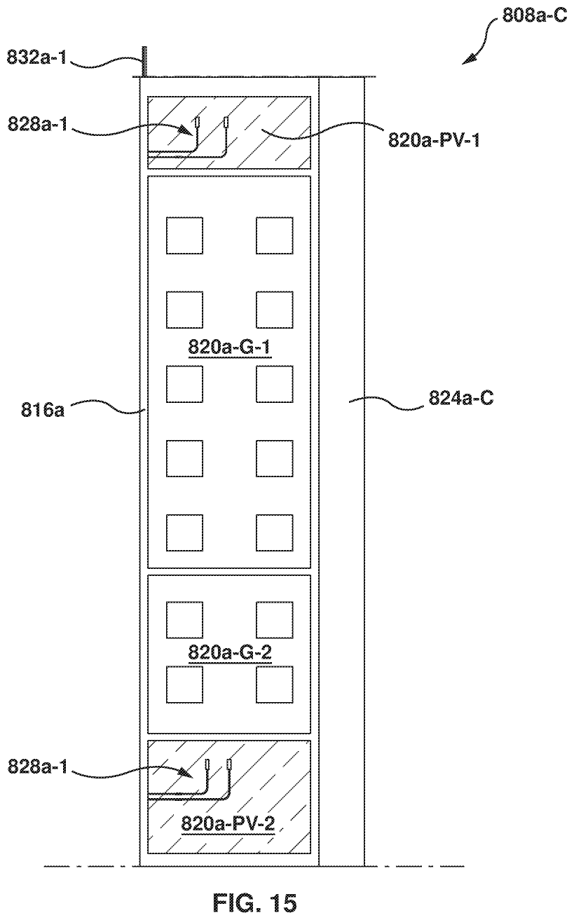

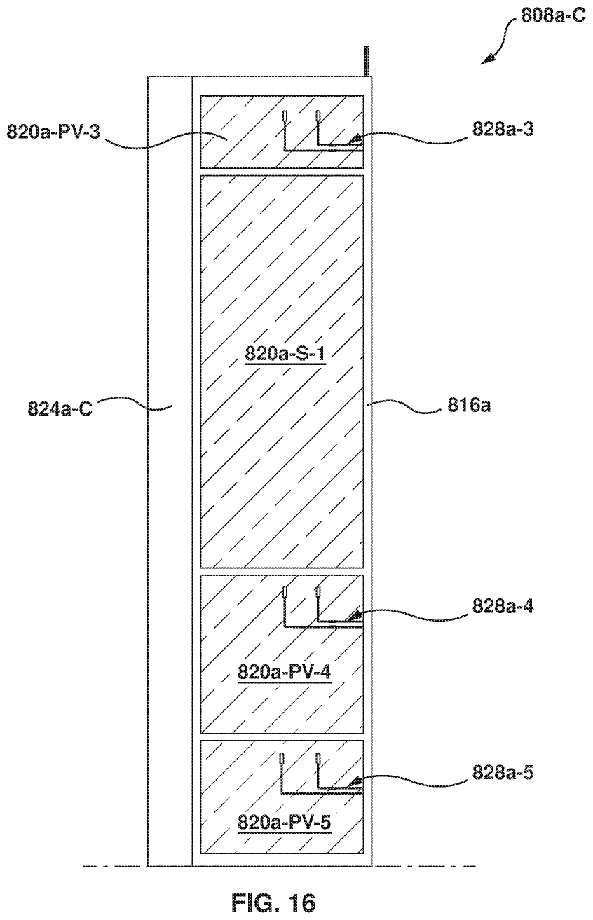

FIG. 12, FIG. 13, FIG. 14, FIG. 15 and FIG. 16 shows different views of a corner panel indicated generally at 808a-C. Corner panel 808a-Ca is a variant on corner panel 808a-C, and thus like elements bear like references, except followed by the suffix “a”. As will become more apparent from the discussion below, panel 808a-C illustrates one of the advantages of the present specification in that the combination of types of units 820 are variable according to the different mullions 824 and the electrical system associated with photovoltaic units 820-PV.

Indeed, corner panel 808a-C includes a different configuration of units 820. Specifically corner panel 808a-C includes five photovoltaic units 820a-PV, two glass units 820a-G, and one traditional spandrel unit 820-S-1. A corner mullion 820a-C defines the ninety degree angle between the two halves of the panel 808a-C. Each photovoltaic unit 820a-PV includes a wiring harness 828a, which is connectable to the electrical output of each photovoltaic unit 820a-PV. As will be discussed further below, each photovoltaic unit 820-PV includes a pair of connectors to permit rapid removal and replacement of photovoltaic unit 820a-PV by disconnecting the leads of the wiring harness 828a during removal and reconnection of the leads of the wiring harness 828a upon replacement of the photovoltaic unit 820-PV. Wiring harnesses 828a connect to respective sets of frame wiring (not shown in FIG. 12) which run along the two exterior vertical members of frame 816a and are collected at a head end 832a. Head end 832a-1 thus combines and collects the electrical power generated by photovoltaic unit 820a-PV-1 and photovoltaic unit 820-PV-2, while head end 832a-2 thus combines and collects the electrical power generated by photovoltaic unit 820a-PV-3, photovoltaic unit 820a-PV-4 and photovoltaic unit 820a-PV-5 as harvested at their respective wiring harnesses 828a.

In general terms, glass units 820a-G are transparent while photovoltaic units 820a-PV are opaque. However, in the event a transparent (or semi-transparent) photovoltaic unit 820a is available, then such a transparent (or semi-transparent) photovoltaic unit 820a can function both as a source of electricity generation and a transparent medium for occupants to look through.

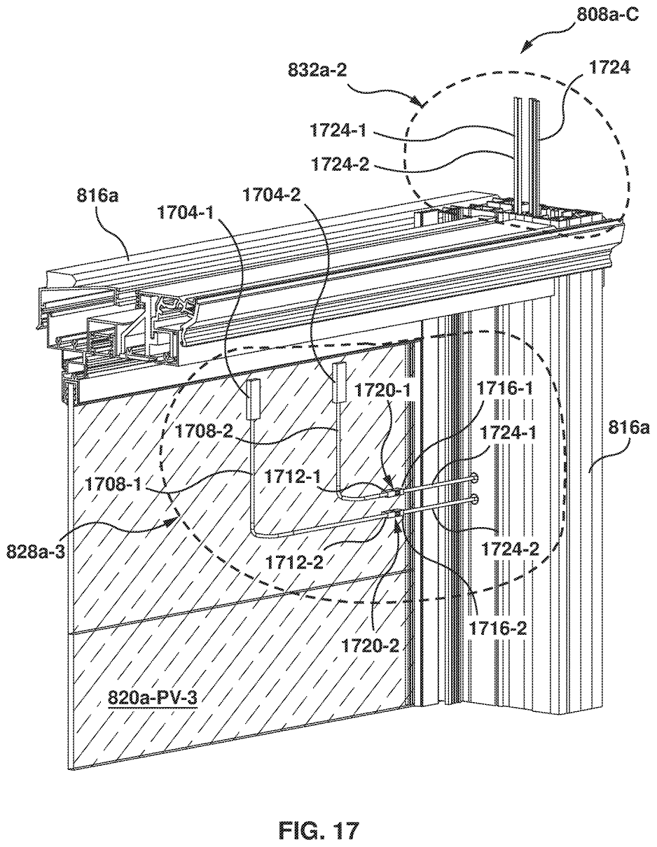

FIG. 17 is a partial perspective view of the top right of corner panel 808a-C. FIG. 17 shows photovoltaic unit 820a-PV-3 in greater detail, with wiring harness 828a-3 shown in greater detail. Harness 828a-3 includes a pair of electrodes 1704 which provide a physical junction between the solar-cells of unit 820-PV-3 and a corresponding pair of wires 1708. To elaborate, electrode 1704-1 feeds into wire 1708-1, and electrode 1704-2 feeds into wire 1708-2. Wire 1708-1 terminates at a first connector end 1712-1, and wire 1708-2 terminates at a second connector end 1712-2.

Connector end 1712-1 removably mates with a complementary connector end 1716-1, and connector end 1712-2 removably mates with a complementary connector end 1716-2. Thus, when mated, connector end 1712-1 and complementary connector end 1716-1 form a complete connector 1720-1. Complementary connector end 1716-1, in turn, feeds into wire 1724-1, which enters frame 816a and runs vertically within frame 816a (not shown) until it exits at head end 832a-2. The same configuration applies to connector end 1712-2 and its complementary connector end 1716-2, which feeds into wire 1724-2 and passing through frame 816a until it exits at end 832a-2.

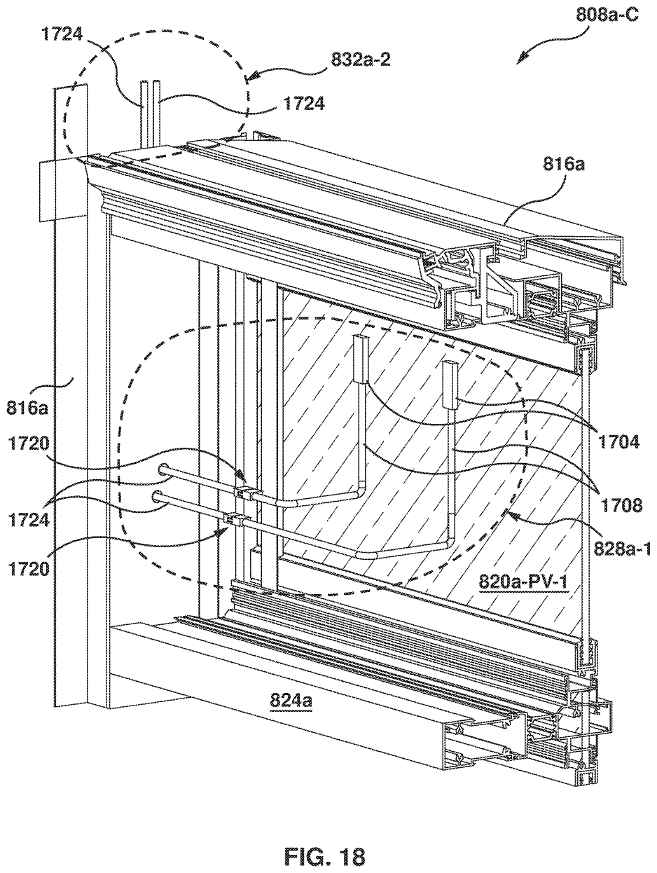

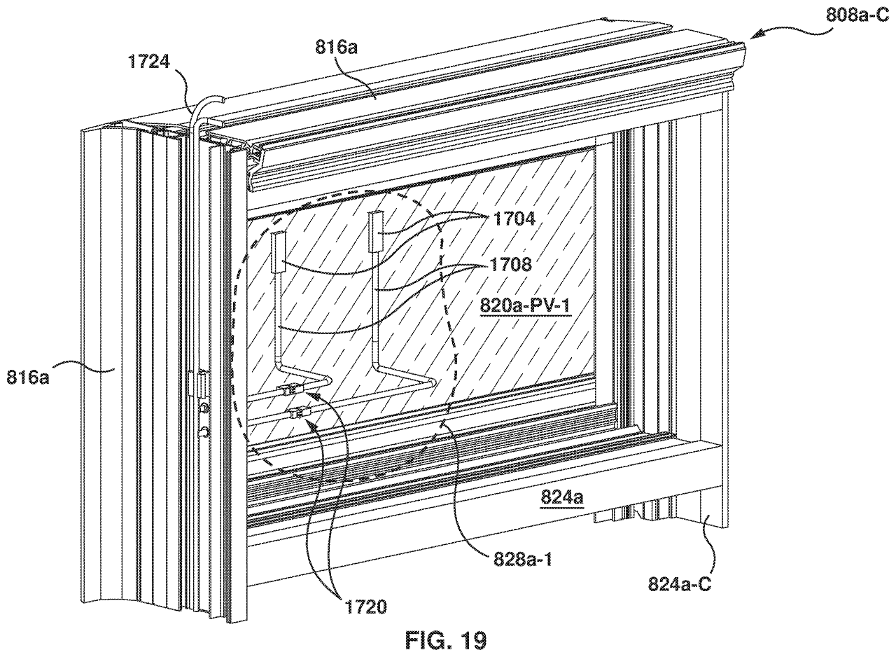

The wiring harness 828a-3 as illustrated in FIG. 17 is similarly configured for the other wiring harnesses 828a for the other photovoltaic units 820a-PV. FIG. 18 and FIG. 19 make this point by showing different perspective views of wiring harness 828a-1 in greater detail, with generic labels for the various components that are analogous to the same components in FIG. 17. A person of skill in the art will now appreciate how the remainder of wiring harnesses 828a can be implemented, including variants to accommodate for different geometries, types of photovoltaic panels, and other design choices. For example, it should be understood that connectors 1720 can be implemented in a variety of forms, including pin and sleeve, blade connectors, bullet connectors, spade connectors, and many others, each with their own specific use cases and standards. Connectors 1720 can come in waterproof and dustproof designs for more demanding environments. As will be discussed in greater detail below, in certain embodiments, each photovoltaic units 820a-PV are configured to be replaceable if damaged or at end-of-life, or as part of a preventive maintenance cycle of system 100, by removing the photovoltaic unit 820a-PV from the portion of the frame 816a and/or mullion 824a that supports it, with connectors 1720 facilitating the rapid disconnection of wires 1724 from wires 1708 of the old photovoltaic unit 820a-PV, and rapid reconnection of the replacement.

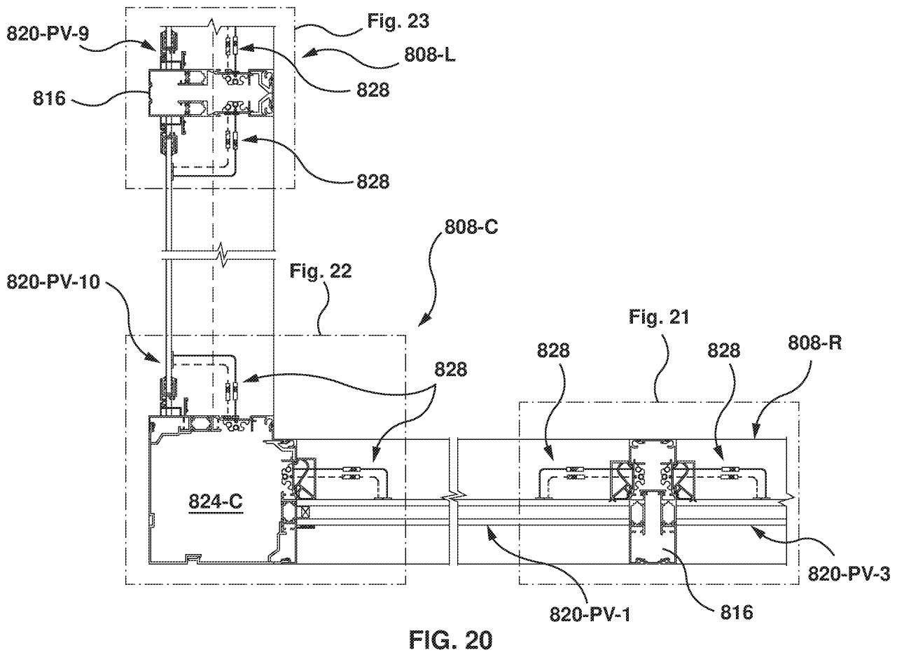

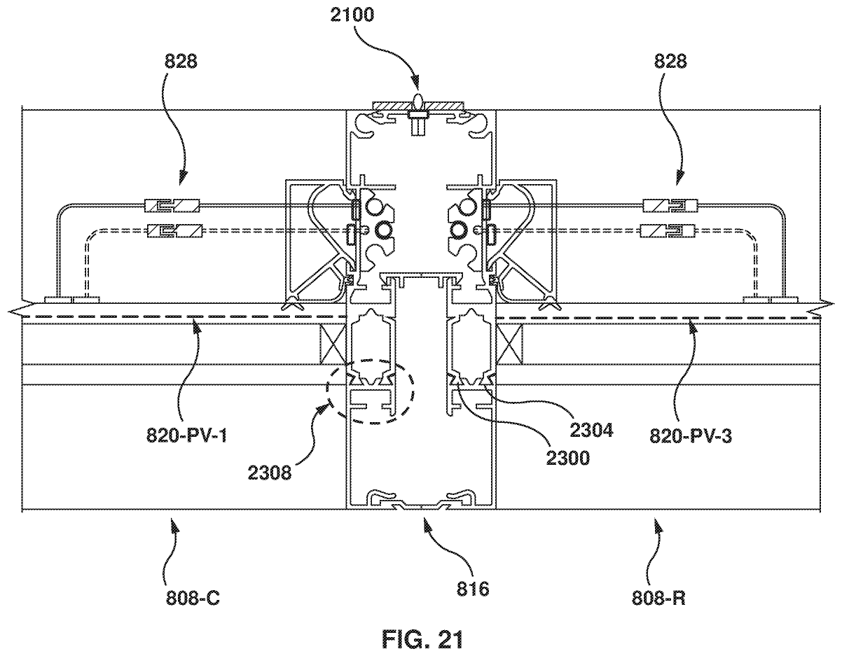

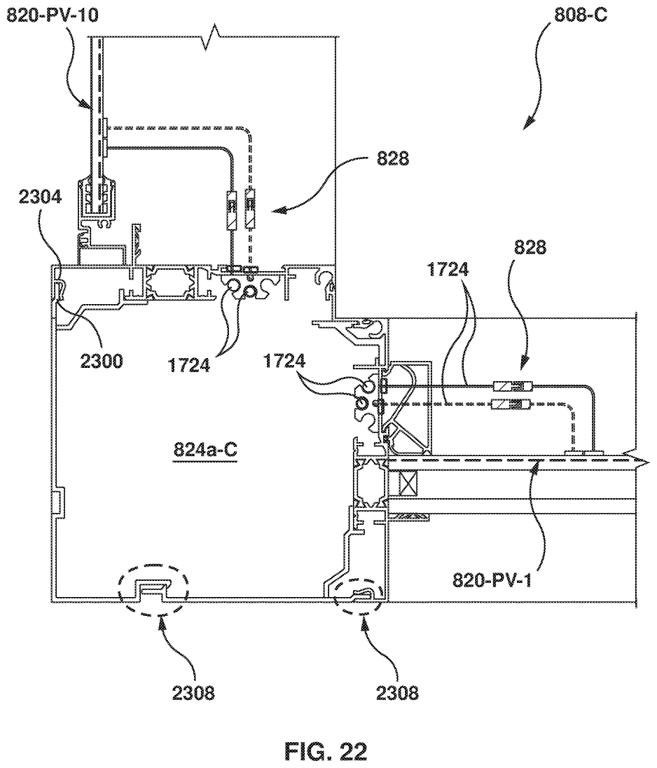

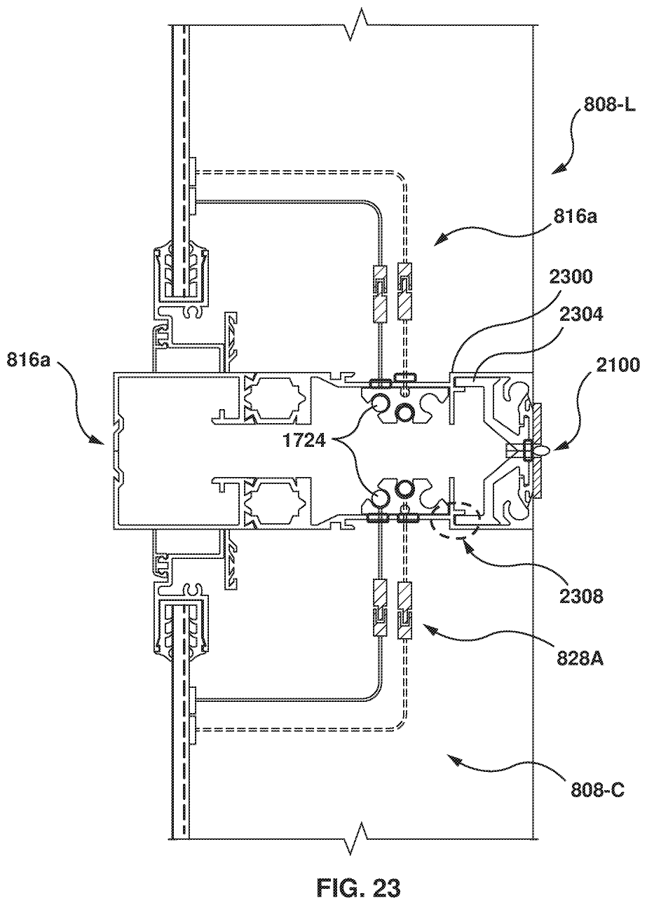

Referring now to FIG. 20, a top sectional view of the building 804 from FIG. 11 is shown, with a focus on corner panel 808-C and sections of left panel 808-L and right panel 808-R. FIG. 21, FIG. 22 and FIG. 23 are detail views of the respective call-outs indicated in FIG. 20.

(Note that FIG. 20, FIG. 21, FIG. 22 and FIG. 23 refer back to the embodiment of FIG. 11, and therefore do not specifically refer to the variant corner panel 808a-C from FIG. 12, FIG. 13, FIG. 14, FIG. 15, FIG. 16, FIG. 17, FIG. 18, and FIG. 19, although a person of skill in the art will continue to recognize that panel 808a-C and panel 808-C are variants of each other, and thus the configurations of each as described herein inform the teachings of each other.)

In FIG. 20, photovoltaic units 820-PV have two wiring harnesses 828a, one at each end. Also of note is that photovoltaic unit 820-PV-1 and photovoltaic unit 820-PV-3 are double-glazed, whereas photovoltaic unit 820-PV-10 and photovoltaic unit 820-PV-9 having single glazing. These are illustrative variant design choices and the specific configuration in FIG. 20 of double and single glazing is not particularly limited. In general terms, however, photovoltaic units 820-PV having wiring harnesses 828a that allow for the removal and replacement of photovoltaic units 820-PV in substantially the same fashion as described above.

In FIG. 21 and FIG. 23, an optional light emitting diode 2100 (or “LED 2100”) is provided on the interior of frame 816a which is connected to wires 1724, although the specific wiring is not shown. LED 2100 can be configured to glow or become active when power is being delivered through wires 1724, confirming the activity of photovoltaic units 820-PV.

Also of note, in FIG. 21 and FIG. 23, frame 816a is actually provided in two parts, with each half of frame 816a being respective to a corresponding adjacent panels 808. Frame 816a includes a plurality of joining mechanisms found in vinyl or metal siding, square tubing, and various other applications which can be implemented using known “interlocking mechanisms”, “interlocking joints” or “tongue-and-groove joints.” In the attached Figures, there are too many tongue-and-groove joints to label them all, especially given the nomenclature approach. However, various example tongues 2300 and grooves 2304 are shown that together form joints 2308 are shown in FIG. 21, FIG. 22, and FIG. 23. A person of skill in the art will be able to discern others. The exact configuration of these joints 2308 in relation to frame 816 is not particularly limited, but in general provide a means to join units 820 so that they share a common frame 816, with each unit 820 having half of a frame 816, and each including some sort of interlocking mechanism to allow the halves to be joined into a full frame 816. Likewise corner mullion 824 also includes joints 2308 along various portions to allow corresponding units 820 to be joined into a single corner panel 808-C.

To elaborate, the “tongue” is the part that protrudes from one of the pieces to be connected, and the “groove” is the hollow created in the other piece that receives the tongue. When the tongue is inserted into the groove, the two pieces interlock and create a firm connection. When these types of joints 2308 are designed to snap together and require some effort to disengage, they may also be referred to as “snap-fit joints” or “snap-lock joints.” It should be understood, however, that the portions of frame 816 and/or corner mullion 824-C need not be exact halves, and that different types of interlocking mechanism or joining mechanism in addition to “tongue” and “groove” can be used to make panels 808 modular.

Note that such mechanisms and configurations may also be used to form mullions 824 as well.

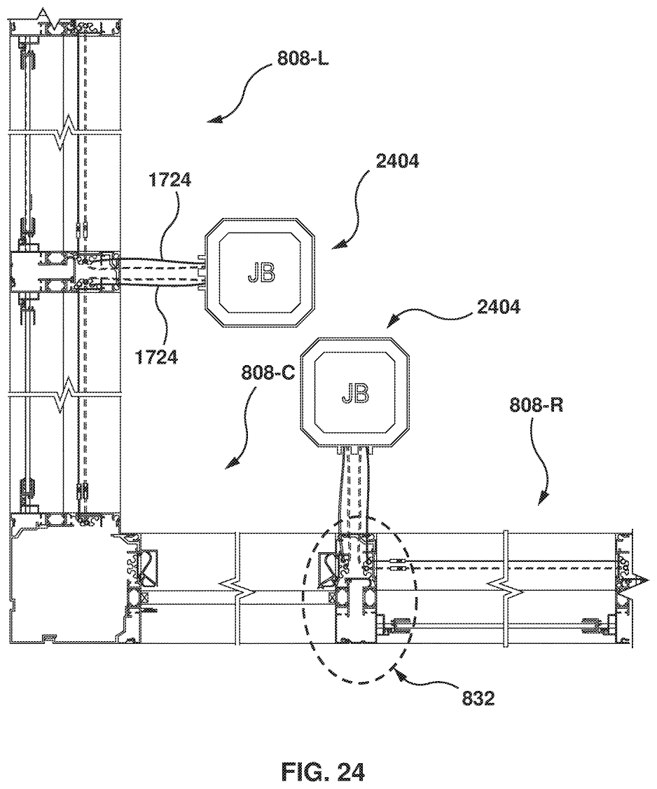

Referring now to FIG. 24, a layered sectional view similar to FIG. 20 is shown with a focus on corner panel 808-C and including left panel 808-L and right panel 808-R. FIG. 24 also includes two junction boxes 2404 which are disposed in the ceiling defined by the underside of the slab of the next floor 812 that is above panels 808. Junction boxes 2404 collect wires 1708 from head ends 832. From there junction boxes 2404 feed into an electrical conduit or cable run to a central location in building 804, where a controller and/or battery system and/or power distribution system and/or combinations thereof can be used to harness electricity generated by photovoltaic units 820-PV.

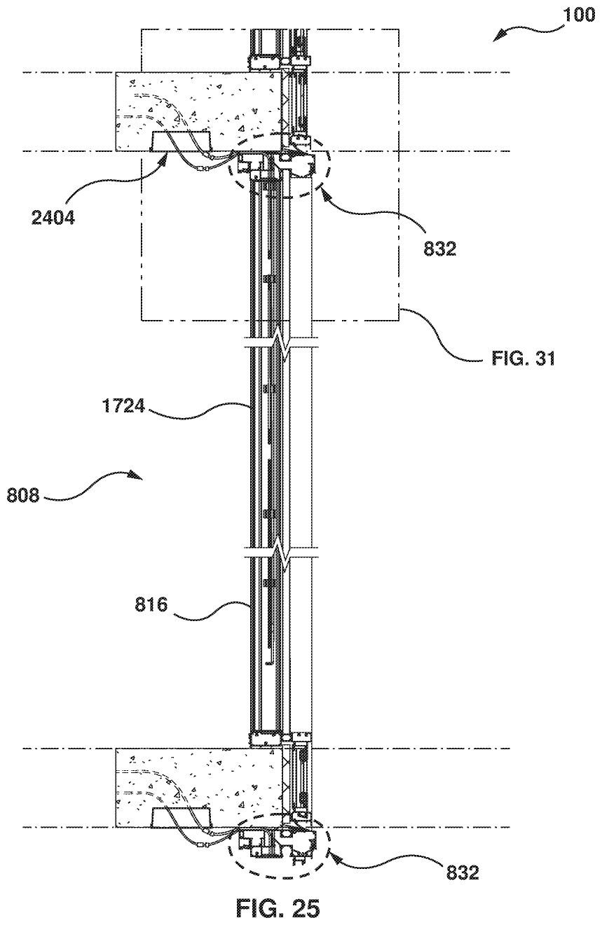

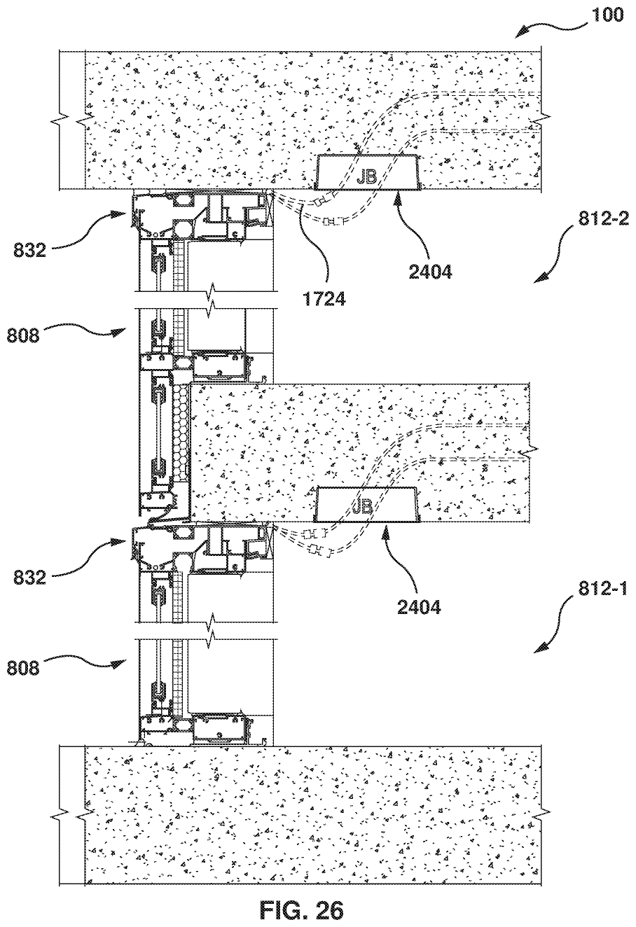

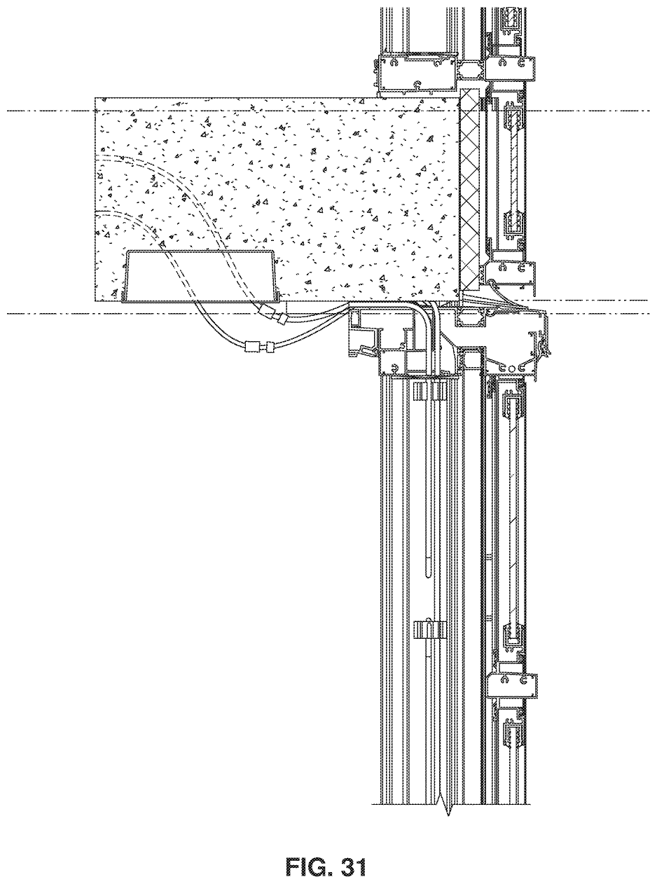

FIG. 25 conveys similar information to FIG. 24. FIG. 25 is a side-sectional view of a panel 808 along a portion of frame 816 that is respective to the panel 808. Wires 1708 are shown as collecting at head end 832, which in turn get collected at junction box 2404. Another side-sectional view similar to FIG. 25 is shown in FIG. 26. In FIG. 26, an interrupted view of two floors 812 is shown, with head ends 832 again collecting wires 1708 into junction boxes 2404. (A detail of this portion of FIG. 25 is shown in FIG. 31). Note that a variant contemplates that wires 1708 can be collected into a junction box 2404 on the floor 812 below the panel 808 if desired.

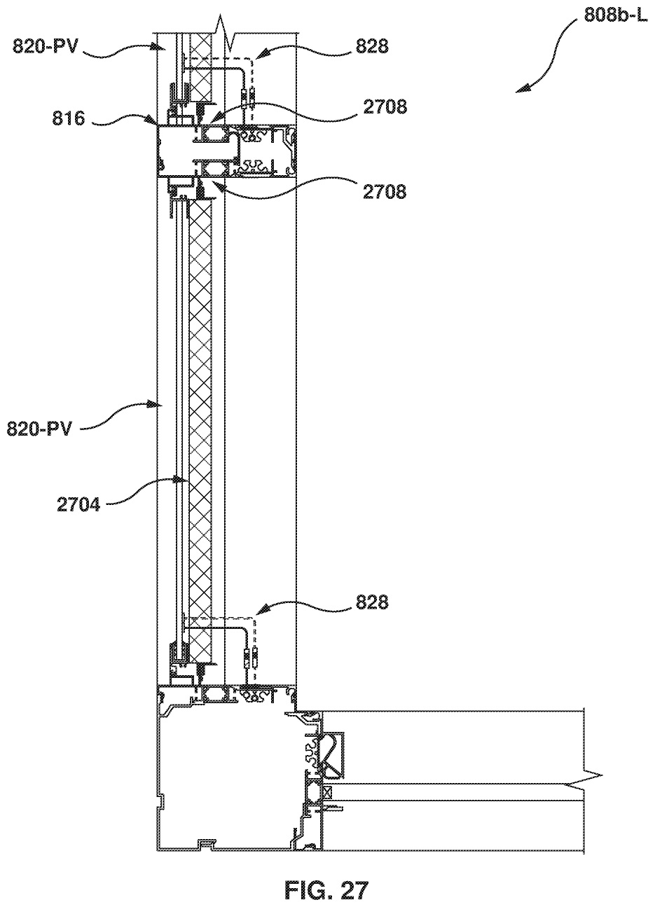

FIG. 27 shows two panels 808b, which are a variant on panels 808, from a top sectional view similar to FIG. 20. Panel 808b include an additional insulation layer 2700 behind the solar glass of their photovoltaic units 820-PV. It is generally coextensive with the photovoltaic unit 820-PV. A sealant 2704 or adhesive is applied between insulation layer 2700 and the solar glass. A presently preferred insulation layer 2700 is about one inch in thickness and is a vacuum sealed insulation panel having about an R65 rating. An example source includes the Panasonic Advance Vacuum Insulation Panel (VIP) being about 24 mm thick and about R66 per inch, available from Panasonic Canada Inc. 5770 Ambler Drive, Mississauga Ontario, L4W 2T3, or via its affiliates or its parent corporation. A presently preferred sealant is like a silicone adhesive such as GE “Iron Grip” branded silicone adhesive by the General Electric Company of Boston Massachusetts. A dry seal, such as silicone, can be applied at each end of the insulation layer 2700.

Using techniques herein, an R value for system 100 can be from about R4 to about R5 at a lower end to about R20 to about R25 at the upper end; the upper end being achieved via layer 2700, where system 100 includes about 60 percent spandrel panels 110 and about 40 percent glass units 115.

Insulation layer 2700 as applied has the advantage of improving the thermal efficiency of building 804, while at the same time facilitating power generation by units 820-PV, and at the same time the inclusion of wiring harnesses 828 preserve the ability to rapidly remove and replace units 820-PV as discussed above.

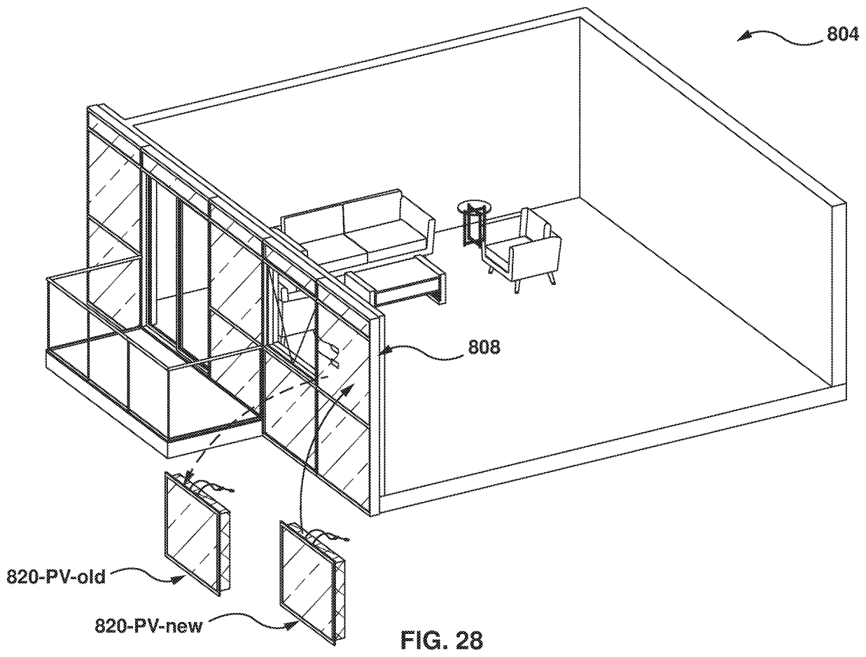

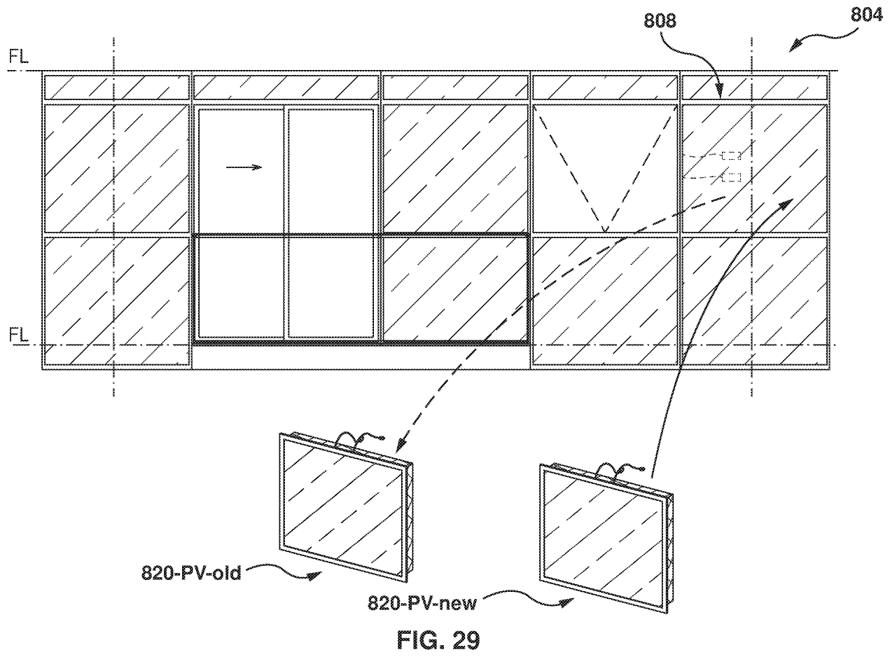

FIG. 28 and FIG. 29 illustrate a removal of an old photovoltaic unit 820-PV-old from a panel 808 and its replacement with a new photovoltaic unit 820-PV-new, within the context of a portion of building 804.

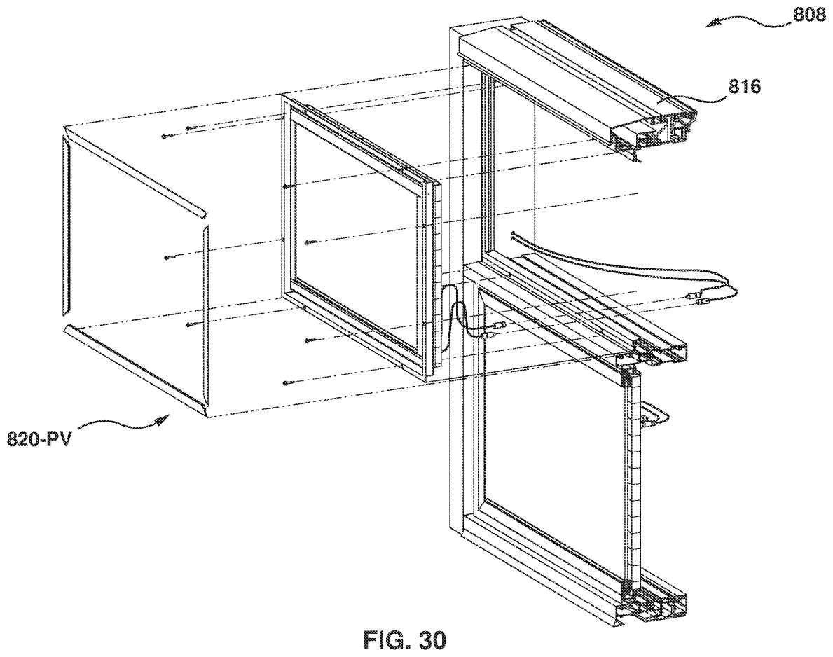

FIG. 30 show a more detailed, non-limiting example of how a unit 820-PV can be removably mounted within frame 816 and/or mullions within the frame 816. Notably, unit 802-PV is removably securable within the frame using a plurality of removable fasteners along the periphery of the photovoltaic spandrel. The fasteners can be, for example, screws that can be accessed from the exterior of the building 804. Note that while not shown in the Figures, unit 820-PV can be modified so that it can be changed or replaced via access from the interior of the building 804. Other types of fasteners that are contemplated include mechanical substitutes for screws, such as wingnuts, thumbscrews, snap fasteners, quick-release pins, magnets and/or combinations thereof. Other types of fasteners will occur to those of skill in the art, with the objective of providing a weatherproof seal that is also readily removable.

While the foregoing discusses certain embodiments, it is to be understood that variations, combinations, and/or subsets of those embodiments are contemplated. For example, one or more control units can be placed within each unit 820, such as within the frame 816. These control units can regulate power before its delivery to junction boxes 2404. In this manner, the power collected at junction boxes 2404 can be clean and normalized before centralized collection from all of the units 820 in the building 804 or a plurality of surrounding buildings 804. Moreover, power from units 820 can be combined with power generated from other sources on the electrical grid, such as from one or more centralized power generation stations utilizing non-renewable or renewable resources. Alternatively, or in addition, power from units 820 can feed into the grid, rather than directly powering building 804. Furthermore, power from units 820 can be combined with other power sources local to building 804, such as rooftop solar panels, rooftop wind turbines, local diesel generators, local hydrogen fuel cells, and the like. Control units can be provided in various configurations, including: integrated into units 820, at collection points such as junction boxes 2404, or centrally within building 804. These control units are configured to normalize the power output in terms of an electricity profile, for example, voltage, current and/or waveform, to ensure consistency with other power sources and/or power-consuming devices within building 804 and the grid in its vicinity.

The present specification provides certain advantages over the prior art especially in view of the climate crisis and the drive toward carbon neutrality. While photovoltaics have come along way, cladding a building with them has proved to be elusive, especially with the challenge of the fact that photovoltaic units may reach end of life well before the building structure reaches end of life. At the same time, thermal insulation should be considered. Accordingly, the present specification provides a window wall system where the photovoltaics can be replaced as part of a routine maintenance program, while at the same time, in certain embodiments, providing meaningful thermal insulation.

The scope of the monopoly of this specification is defined by the claims, properly construed in relation to the narrative and drawings. Any limiting phrases should not be viewed in isolation but in view of the broader context of the entire teachings and advantages afforded by the specification.

What is claimed is:

1. A solar electric energy wall system comprising:
a plurality of solar spandrels and glass vision panels integrated into unitized cladding wall units for cladding a building structure; said plurality of unitized cladding wall units further carrying electrical wiring within at least a portion of the frames of said plurality of unitized cladding units.

2. The solar electric energy wall system of claim 1 wherein a plurality of control modules are integrated within said unitized window wall units; said control units each optimizing a power output of at least one of said plurality of energy conversion devices.

3. The solar electric energy wall system of claim 1 wherein the solar spandrels and glass vision panels are disposable around a substantial portion of the building structure.

4. The solar electric energy wall system of claim 1 wherein the solar spandrels are removably replaceable within each cladding wall unit.

5. A cladding panel for a building comprising:
a frame having at least one vertical member and at least one horizontal member;
at least one solar spandrel disposed within the frame having an electrical connection; a photovoltaic surface of the spandrel for positioning on the exterior of the building;
a set of wiring passing at least through the at least one vertical member for delivery to a junction box disposed in a floor or ceiling of the building proximal to the at least one horizontal member; the wiring for delivery of electricity from the electrical connection to the junction box.

6. A cladding panel for a building comprising:
a frame having at least one vertical member and at least one horizontal member;
at least one solar spandrel disposed within the frame having an electrical connection; a photovoltaic surface of the spandrel for positioning on the exterior of the building;
a set of wiring passing at least through the at least one vertical member for delivery to a junction box disposed in a floor or ceiling of the building proximal to the at least one horizontal member; the wiring for delivery of electricity from the electrical connection to the junction box.

7. The system of claim 6, wherein said exterior shell encloses a substantial portion of a vertical surface of said building structure which receives solar radiation.

8. The cladding panel of claim 6 wherein the electrical connection is removably connectable to the wiring and the photovoltaic spandrel is removably mountable within the frame, such that the solar spandrel is replaceable during maintenance of the building.

9. The cladding panel of claim 8 wherein the photovoltaic spandrel is removably securable within the frame using a plurality of removable fasteners along the periphery of the photovoltaic spandrel.

10. The cladding panel of claim 9 wherein the fasteners comprise one or more of screws, wingnuts, thumbscrews, snap fasteners, quick-release pins and magnets.

11. The cladding panel of claim 6 further comprising an insulation layer between the solar spandrel and the interior of the building.

12. The cladding panel of claim 11 wherein the insulation layer is vacuum sealed insulation panel having a thickness of about one inch.

13. The cladding panel of claim 11 wherein the insulation layer has a thermal insulation rating of about R65.

14. The cladding panel of claim 6 further comprising at least one transparent glass unit adjacently positioned within the frame beside the solar spandrel.

15. The cladding panel of claim 6 wherein the panel includes a corner mullion to form a corner panel for the building.

16. The cladding panel of claim 6 wherein the panel is part of a window wall system.

17. The cladding panel of claim 6 wherein the panel is part of a curtain wall system.

18. The cladding panel of claim 6 further comprising a control unit for normalizing an electricity profile generated by the photovoltaic surface with the profile of a power grid for the building.

19. The cladding panel of claim 6 wherein the at least one vertical member comprises a joining mechanism for interlocking attachment to a complementary vertical member of a frame of an adjacent cladding panel.

20. The cladding panel of claim 19 wherein the adjacent cladding panel also comprises at least one solar spandrel.
